(19) United States
(12) Patent Application Publication
(10) Pub. No.: US 2002/0096655 A1
(43) Pub. Date: Jul. 25, 2002

(54) Canister purge valve for high regeneration airflow

(75) Inventor: David William Balsdon, Chatham (CA)

Correspondence Address: MORGAN LEWIS & BOCKIUS LLP, 1111 PENNSYLVANIA AVENUE NW, WASHINGTON, DC, 20004, US

(73) Assignee: Siemens Canada Limited

(21) Appl. No.: 10/103,489

(22) Filed: Mar. 22, 2002

Related U.S. Application Data
(62) Division of application No. 09/592,907, filed on Jun. 13, 2000.
(60) Provisional application No. 60/139,159, filed on Jun. 14, 1999.

(51) Int. Cl. F16K 31/02

(52) U.S. Cl. 251/129.18

(57) ABSTRACT

A solenoid purge valve in which the coil is encapsulated by a plastic cap that is overmolded. In addition, a calibration feature may also be integrated with the cap and coil into a single component that can also include an electrical connector. The entire assembly may be adapted to be coupled, for example by snapping, to a discrete lower body portion or to an intake manifold.

### CROSS REFERENCE TO RELATED APPLICATIONS

This application claims the benefit of the earlier filing date of U.S. Provisional Application No. 60/139,159, filed on Jun. 14, 1999, which is incorporated by reference herein in its entirety.

### BACKGROUND OF THE INVENTION

The claimed invention generally pertains to linear solenoid purge valves. In particular, the claimed invention pertains to an overmolded coil for a subassembly of a linear solenoid purge valve. The claimed invention also pertains to a method of constructing the overmolded coil, subassembly, and linear solenoid purge valve.

The development of a linear solenoid purge valve began in the early 1990's. The result of the development was a proportional purge solenoid. However, there has been a continued need to increase the durability and robustness of these valves, to facilitate their manufacture, and to reduce the costs associated with their manufacture.

### SUMMARY OF THE INVENTION

The claimed invention provides a purge solenoid valve assembly having a valve driven by a solenoid. The assembly comprises a coil which, when energized, drives the valve; and a cap. The cap is overmolded and the coil is encapsulated in the cap.

The claimed invention also provides a purge solenoid valve assembly having a valve driven by a solenoid. The assembly comprises a bobbin; a wire wound around the bobbin; at least one terminal electrically connected to the wire; and an overmolded cap generally encapsulating the bobbin and the wire. The overmolded cap includes a connector body formation partially encapsulating the at least one terminal.

The claimed invention additionally provides a method of assembling a linear solenoid purge valve component. The method comprises winding a wire around a bobbin; electrically connecting the wire to a terminal; and overmolding a cap that generally encapsulates the wire and bobbin, and that partially encapsulates the terminal.

### BRIEF DESCRIPTION OF THE DRAWINGS

FIG. 1 is a perspective view of an overmolded coil according to the claimed invention.

FIG. 2 is a cross-section view of the overmolded coil shown in FIG. 1.

FIG. 3 is a perspective view of a sub-assembly including the overmolded coil shown in FIG. 1, which is ready for attachment to a lower body or a manifold.

FIG. 4 is a perspective view of a linear purge solenoid valve including the sub-assembly shown in FIG. 3, which is mounted in a lower body style of attachment.

FIG. 5 is a cross-section view of the linear purge solenoid valve shown in FIG. 4.

### DESCRIPTION OF THE INVENTION

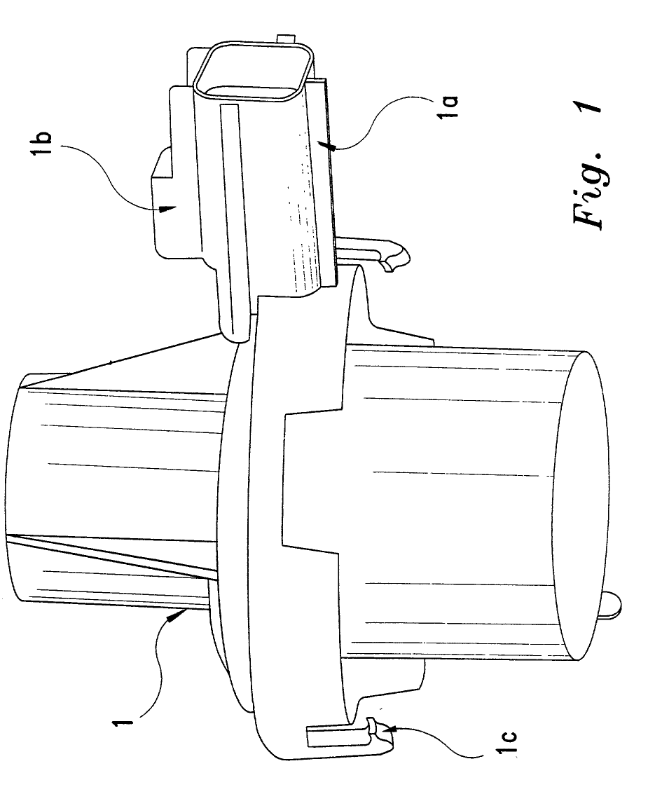

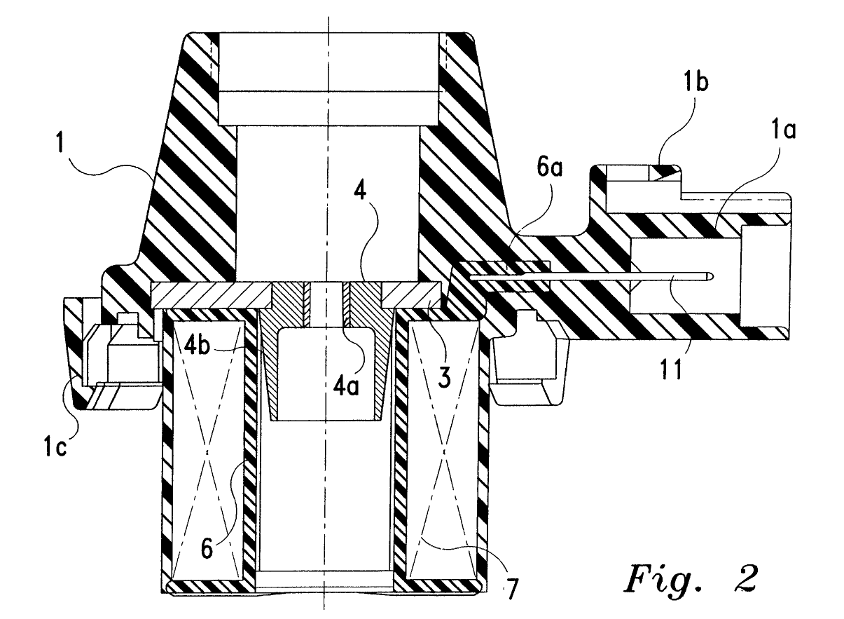

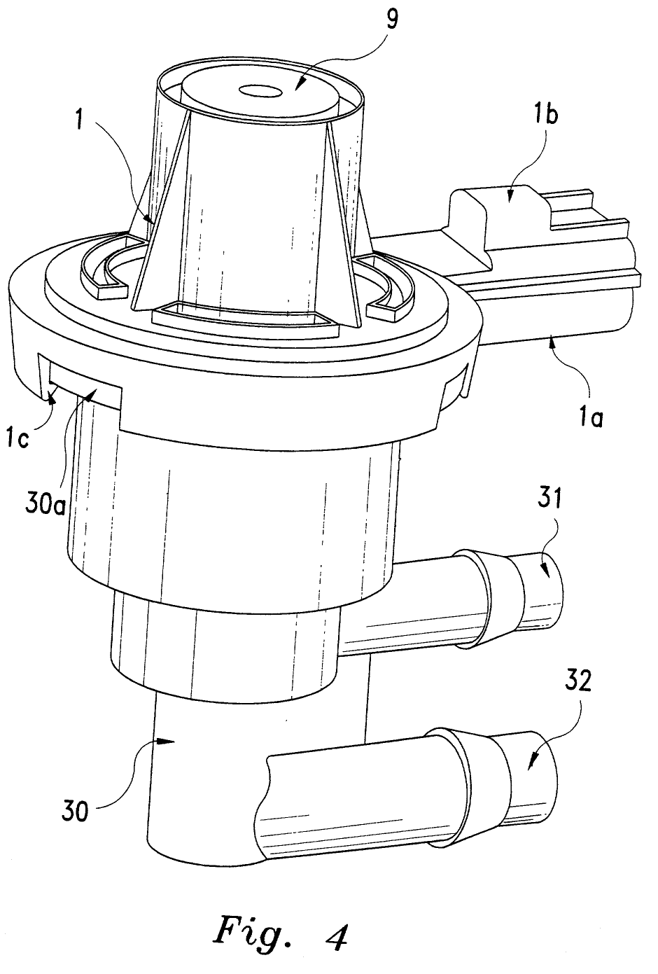

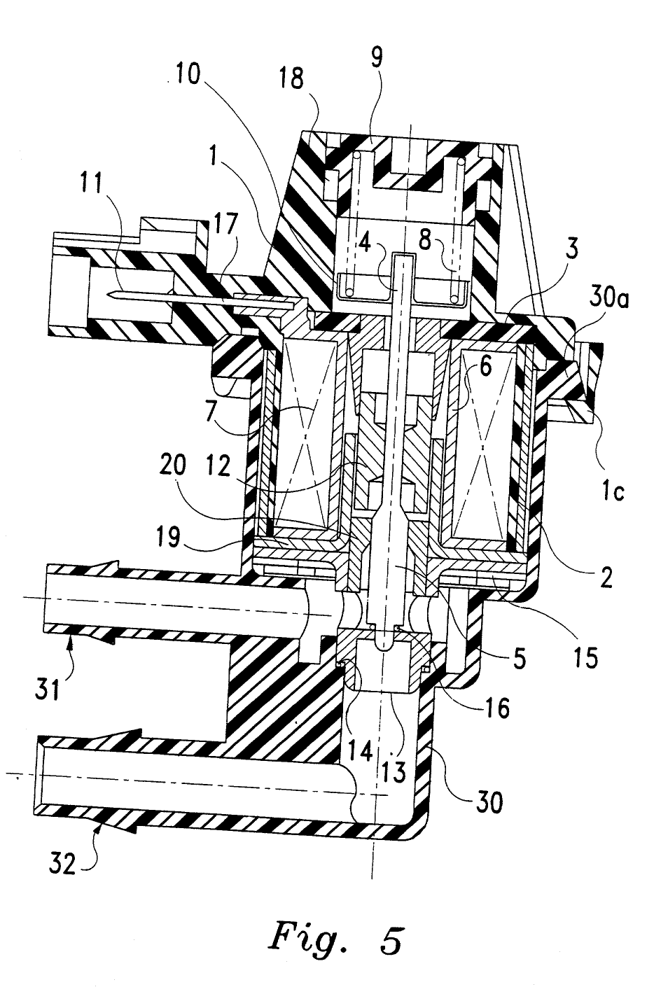

Referring to FIGS. 1-5, the valve according to the present invention addresses a plurality of the previously unmet cost, durability, robustness and manufacturing needs. In particular, these advantages can be provided by an overmolded coil. The overmolded coil can include a cap 1, terminals 11, and a calibration feature (spring 8, upper spring locator 9, and lower spring locator 10), all of which are combined into a single part. The coil of wire 7 can be wound onto a bobbin 6, which can have an integral projection 6a supporting the terminals 11. Of course, ends (not shown) of the wire 7 are electrically connected to respective ones of the terminals 11. The bobbin 6 and integral projection 6a can be an electrical insulator.

In operation, the terminals 11 are electrically interconnected with a vehicle's wiring harness (not shown) using cooperatively engaging connector bodies. The cap 1 can include a connector body formation 1a providing one of the connector bodies. The connector body formation 1a can include a releasable locking feature 1b preventing inadvertent separation of the connector body formation 1a from its cooperative engagement with a corresponding connector body on the wire harness (not shown).

The cap 1 also provides cooperative engagement, e.g., via threaded engagement, with the upper spring locator 9. Relative rotation between the upper spring locator 9 and the cap 1 enables the biasing pressure of the spring 8 to be adjusted, thereby facilitating linear solenoid purge valve calibration.

The cap 1 is overmolded around the bobbin 6 (with the wire 7 and the terminals 11), a stator 3, and an upper bearing unit 4. The unit 4 can include a separate bearing 4a supporting a pin 5 for relative reciprocating movement relative to the cap 1. The unit 4 can also include a collar 4b for guiding an armature 12, which can be fixed to the pin 5. The wire 7 wound around the bobbin 6, the stator 3, and the armature 12 form at least part of a magnetic circuit that is created when current is passed through the wire 7.

Cost savings associated with the claimed invention result at least in part from the integration of the cap 1, coil (wire 7 wound around bobbin 6), and calibration feature (spring 8, upper spring locator 9, and lower spring locator 10) into a single component. Because of this integration, it is possible to eliminate several other components including a strap and a spring locator. In addition, this integration permits an outside metal shell 2 to be simplified, and thus produced at a lower cost. Another advantage of the claimed invention is that the overmolding maintains dimensional stability and alignment, which are no longer dependent on the metal shell 2.

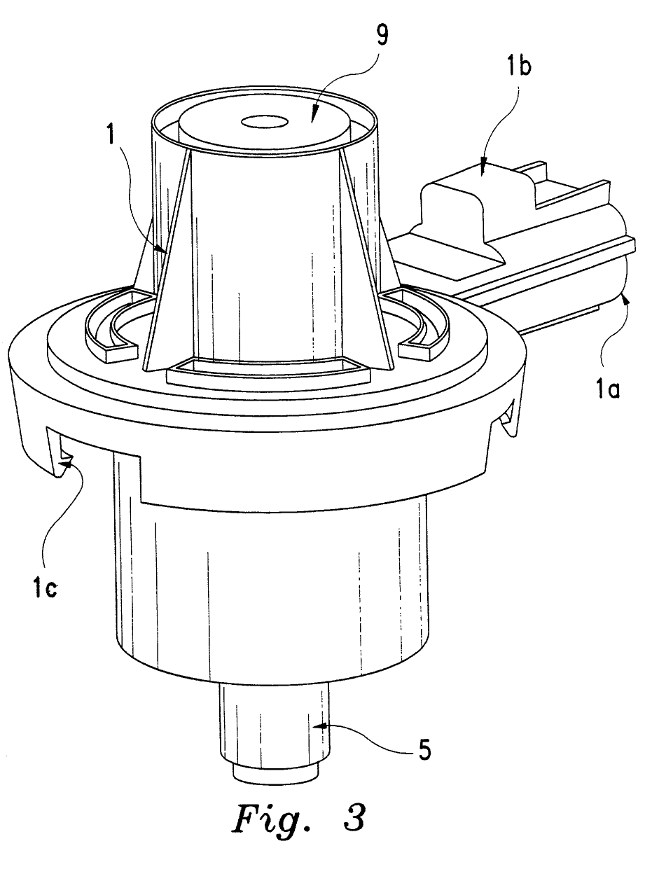

Referring particularly with respect to FIGS. 3-5, a subassembly, including the cap 1 with the overmolded coil, can be further built-up by installing the components 8, 9, 10 of the calibration feature, and by engaging the pin 5, having the armature 12 attached thereto, with the lower spring locator 10. Additionally, a lower bearing unit, including a locator 19 and a lower bearing 20, can be connected to the sub-assembly.

A complete linear solenoid purge valve can further include a body 30 with a valve seat 13 that cooperatively engages with the pin 5 to control fluid flow between a pair of flow tubes 31, 32. The body 30 can include a lip 30a that matingly engages the with snap features 1c on the cap 1. The engagement between the lip 30a and the snap features 1c allow any orientation of the terminals 11 relative to the positioning of the set of flow tubes 31, 32. That is to say, these snap features 1c enable the cap 1 to be turned about its vertical axis so as to orient the connector body formation 1a in any desired direction. A resilient element 15, e.g., a wavy washer, biases the cap 1 with respect to the body 30 to eliminate any play between the engagement of the lip 30a and the snap features 1c.

A number of O-rings and seals 14 and 16-18 can prevent unintended leakage between various component connections in the linear solenoid purge valve.

Overmolding the coil also introduces increased durability and robustness of a linear solenoid purge valve. The cap 1 can be made from any material that is suitable for an overmolding technique. One example of a suitable material is 6/6 Nylon—glass filled. Since the coil is encapsulated as part of the cap 1 and the calibration feature is also contained in the cap 1, and the valve seat 13 and pin 5 position can be established with reference to a feature of the overmolded coil, the calibration feature is not influenced by changes in material dimensions, e.g., changes in the length due to creep or humidity. The coil is securely held in place by the material that encapsulates and forms it into the cap 1. Short of actually breaking it, there is no possibility that the coil can move or relocate relative to the calibration feature if the sub-assembly is subjected to a disturbance such as dropping.

The claimed invention also reduces part count which results in greater ease of manufacture. The lower bearing unit can be pressed onto the coil end of the overmolding and the sub-assembly can then be snapped into either a discrete lower body 30 or into a portion of an intake manifold (not shown).

While the invention has been disclosed with reference to certain preferred embodiments, numerous modifications, alterations, and changes to the described embodiments are possible without departing from the sphere and scope of the invention, as defined in the appended claims and their equivalents thereof. Accordingly, it is intended that the invention not be limited to the described embodiments, but that it have the full scope defined by the language of the following claims.

What is claimed is:

1. A purge solenoid valve assembly having a valve driven by a solenoid, the assembly comprising:
a coil which, when energized, drives the valve; and
a cap;
wherein the cap is overmolded and the coil is encapsulated in the cap.

2. The assembly according to claim 1, further comprising:
a calibration feature encapsulated in the cap.

3. The assembly according to claim 1, further comprising:
an electrical connector, the connector molded as a portion of the cap.

4. The assembly according to claim 1, wherein the assembly is adapted to be coupled by snapping into a discrete lower body.

5. The assembly according to claim 1, wherein the assembly is adapted to be coupled by snapping into an intake manifold.

6. A purge solenoid valve assembly having a valve driven by a solenoid, the assembly comprising:
a bobbin;
a wire wound around the bobbin;
at least one terminal electrically connected to the wire; and
an overmolded cap generally encapsulating the bobbin and the wire, the overmolded cap including a connector body formation partially encapsulating the at least one terminal.

7. The assembly according to claim 6, further comprising:
a pin displaceable with respect to the bobbin when an electric current flows through the wire; and
a pin displacement calibration feature including a resilient element biasing the pin with respect to the overmolded cap and a first locator adjusting the position of the resilient element with respect to the overmolded cap.

8. The assembly according to claim 7, wherein the pin displacement calibration feature further includes a second locator connecting the resilient element with respect to the pin.

9. The assembly according to claim 7, wherein the resilient element includes a coil spring.

10. The assembly according to claim 7, wherein the first locator threadably engages the overmolded cap.

11. The assembly according to claim 6, wherein the overmolded cap further includes a locking feature adapted for releasable retaining an electrical connector with respect to the connection body formation.

12. The assembly according to claim 6, wherein the overmolded cap further includes a snap fastening feature adapted for securing the overmolded cap to a mount.

13. The assembly according to claim 12, wherein the snap fastening feature is adapted for enabling the connection body formation to be reoriented with respect to the mount.

14. The assembly according to claim 7, further comprising:
at least one bearing unit guiding displacement of the pin with respect to the cap;
a stator at least partially encapsulated by the overmolded cap and magnetically connected to a magnetic field created by the electric current flowing through the wire; and
an armature portion of the pin responsive to the magnetic field.

15. The assembly according to claim 14, wherein the resilient element includes a coil spring, the pin displacement calibration feature further includes a second locator connecting the coil spring with respect to the pin, and the first locator threadably engages the overmolded cap.

16. The assembly according to claim 15, wherein the overmolded cap further includes a locking feature adapted for releasable retaining an electrical connector with respect to the connection body formation, and also further includes a snap fastening feature that enables the connection body formation to be reoriented with respect to a mount having a valve seat that engages the pin to control fluid flow.

17. A method of assembling a linear solenoid purge valve component, the method comprising:
winding a wire around a bobbin;
electrically connecting the wire to a terminal; and
overmolding a cap that generally encapsulates the wire and bobbin, and that partially encapsulates the terminal.

18. The method according to claim 17, further comprising:
providing a resilient element biasing a first locating member with respect to the cap;
engaging a second locating member with respect to the cap; and
adjusting the second locating member with respect to the cap to vary the biasing force between the first locating member and the cap.

19. The method according to claim 17, further comprising:
providing a pin adapted for reciprocal movement with respect to the bobbin;
providing at least one bearing between the pin and the cap; and
connecting the cap with a mount, the mount having a valve seat adapted for engaging the pin to control fluid flow.

20. The method according to claim 19, further comprising:
adjusting the cap to reorient a connector body formation of the cap with respect to the mount.
